(19) United States
(12) Patent Application Publication
(10) Pub. No.: US 2006/0253310 A1
(43) Pub. Date: Nov. 9, 2006

(54) Capability assessment of a training program

(75) Inventors: Peter Herbert Fuchs, Stamford, CT (US); Barton L. Doubet, Denver, CO (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH, Schaffhausen (CH)

(21) Appl. No.: 11/124,702

(22) Filed: May 9, 2005

(51) Int. Cl. G05B 19/418; G06F 15/02; G06F 9/46

(52) U.S. Cl. 705/8; 705/9

(57) ABSTRACT

Methods and apparatuses for profiling and modifying the training program of a company. Characteristics of the training program are aligned to a set of training supply chain components of a capability assessment model. The components are assessed and reported to show a comparison of the company with the leader in the associated business segment by categorizing the components. An assessment report is displayed that includes indicia indicative of a comparison of the company's training program with the business segment leader for each component of the training program model. The indicia may further reflect a degree of difference between the training program of the company and the business segment leader. Training characteristics associated with at least one component of a training program may be recommended from the assessment results to change the categorization of the at least one component.

### FIELD OF THE INVENTION

This invention relates generally to a capability assessment model for a company's training program. More particularly, the invention provides methods and systems for profiling and modifying the training program.

### BACKGROUND OF THE INVENTION

In order to be competitive, companies are continuously training its employees to learn necessary skills and to update its workforce about current procedures. However, in order to be competitive in its business segment, a company must consider training expenses in relation to the resulting benefits. Not spending enough money on training may adversely affect the company's competitive stature. Spending too much money may result in being competitive but causing an excessive amount of resources to be expended and adversely affecting the profitability of the company. Moreover, a company's workforce may be defocused from regular work activities by being overly preoccupied with training.

Therefore, there exists a need in the art for systems and methods that enable a company to analyze whether its training is sufficient to be competitive in its business segment and to obtain recommendations for modifying its training program.

### BRIEF SUMMARY OF THE INVENTION

The present invention provides methods and apparatuses for profiling and modifying the training program of a company.

With one aspect of the invention, characteristics of the training program are aligned to a set of training supply chain components of a capability assessment model. The components are assessed and reported to show a comparison of the training program with the leader, an average, or some other reference in the associated business segment.

With another aspect of the invention, training characteristics that are associated with at least one component of a training program of a company are recommended from assessment results. The recommendations are in concert with the business segment of the company.

With another aspect of the invention, components of a company's training program are categorized and compared to a leader in the associated business segment. With an exemplary embodiment, components are categorized into one of four categories.

With another aspect of the invention, costs and benefits for changing training characteristics of a training program component are determined. If the resulting profit is sufficient, then a model of the training program is modified to change the category of at least one component of the training program.

With another aspect of the invention, an assessment report is displayed that includes indicia indicative of a comparison of the company's training program and a reference for each component of a training program model. The indicia may further reflect a degree of difference between the company and the reference.

With another aspect of the invention, an apparatus analyzes a training program of a company and a reference in the company's business segment. Training characteristics data are obtained through an input interface, and a processor aligns the training characteristics data to a capability assessment model. The processor compares the training characteristics data with training characteristics of a reference in the business segment and provides an assessment report.

### BRIEF DESCRIPTION OF THE DRAWINGS

The present invention is illustrated by way of example and not limited in the accompanying figures in which like reference numerals indicate similar elements and in which:

FIG. 1 shows a computer system that supports an embodiment of the invention.

FIG. 2 shows definitions for capability assessment categories in accordance with an embodiment of the invention.

FIG. 3 shows an architecture for learning supply chain components according to an embodiment of the invention.

FIG. 4 shows learning supply chain components according to an embodiment of the invention.

FIG. 5 shows an exemplary assessment results report according to an embodiment of the invention.

FIG. 6 shows a flow diagram that assesses a training program according to an embodiment of the invention.

FIG. 7 shows an apparatus that analyzes a training program in a business segment in accordance with an embodiment of the invention.

### DETAILED DESCRIPTION OF THE INVENTION

In the following description, a training program supports the teaching of a workforce on a company. The workforce is referred as “learners” who benefit from the training program. Even though one may refer to learning as a process for an individual, it is understood that the training program provides a corresponding teaching effort that enables the individual to learn.

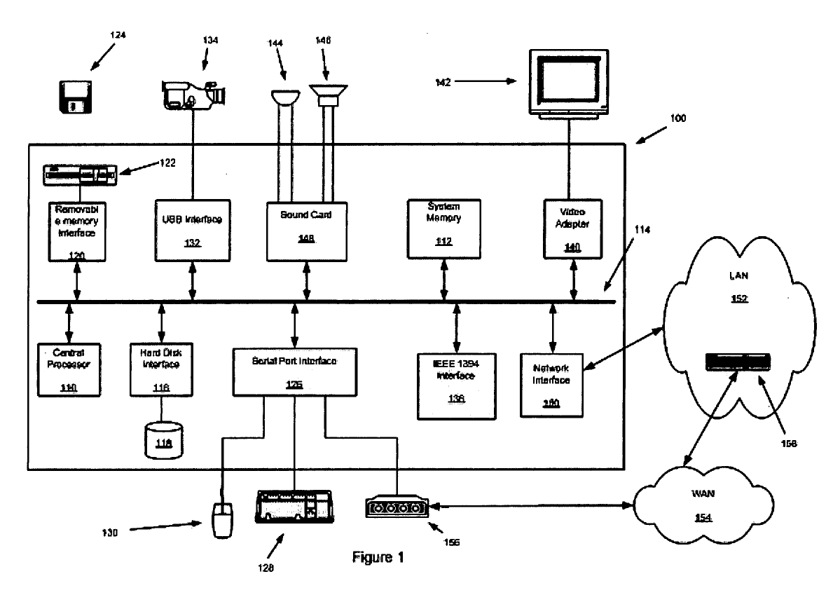

Elements of the present invention may be implemented with computer systems, such as the system 100 shown in FIG. 1. (System 100 may support apparatus 700 as will be discussed.) Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An EEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 166. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

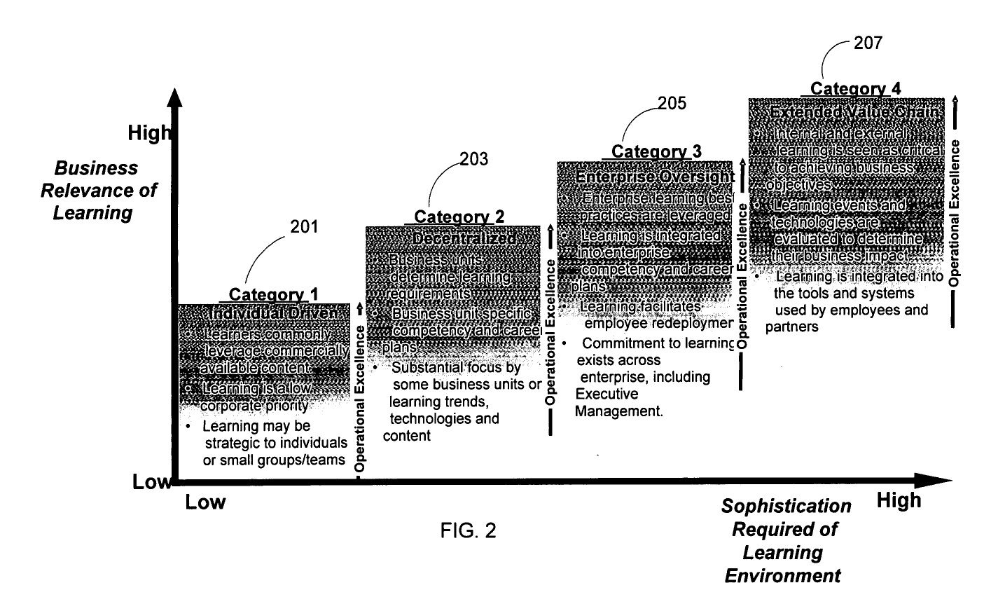

FIG. 2 shows definitions for capability assessment categories in accordance with an embodiment of the invention. In the exemplary embodiment, a company may be categorized into one of four categories: category 1 (201), category 2 (203), category 3 (205), and category 4 (207). In general, the higher the category of a company, the greater that the company views the strategic importance of training (learning by employees, partners, and customers). The learning capabilities of a company can reside in different categories with the majority of capabilities residing in a specific category. These categories are characterized by the following:
Category 1 (Individual Driven): Training commonly leverages commercially available content. Training is typically a low corporate priority but may be strategic to individuals or small groups or teams. Category 1 companies are often start-up companies or established businesses in a stagnant industry. The typical industry focus is small to mid-sized companies and emerging companies.
Category 2 (Decentralized): Business units typically determining training requirements. Each business unit supports specific competency and career plans for members with the business unit. Some of the business units within a company may have substantial focus on learning trends, technologies, and content. Category 2 companies are often decentralized or localized business operating in a relatively stable environment. The typical industry focus is companies in heavy manufacturing, retail, health care, energy, construction, transportation, and advertising and media.
Category 3 (Enterprise Oversight): Companies in category 3 leverage enterprise training best practices. Training is integrated into enterprise competency and career plans. Training enables employees to learn skills in which employees may be redeployed within the company. There is a commitment to learning across the company. Category 3 companies are often integrated and established businesses experiencing moderate change within the company's business segment. The typical industry focus is companies in consumer electronics, traditional telecom, bio-tech, automobiles, large professional services, and brokerage services.
Category 4 (Extended Value Chain): Companies in category 4 view internal and external training as being critical to achieving business objectives. Learning events and technologies are evaluated to determine their business impact on the company's objectives. Moreover, training is integrated into the tools and systems used by employees and partners. Category 4 companies are often rapidly changing businesses with complex products and with a large extended enterprise. The typical industry focus is companies in software/hardware, wireless telecom, defense and aerospace, travel (includes airlines), insurance and banking, pharmaceuticals, and IT services.

Depending on the associated business segment, embodiments of the invention may determine that targeting a higher category may not be practical. For example, it may not be economically justifiable for a steel manufacturing company to be a category 4 company. On the other hand, it may be imperative that a wireless telecom company be a category 4 company in order to be competitive in its business segment.

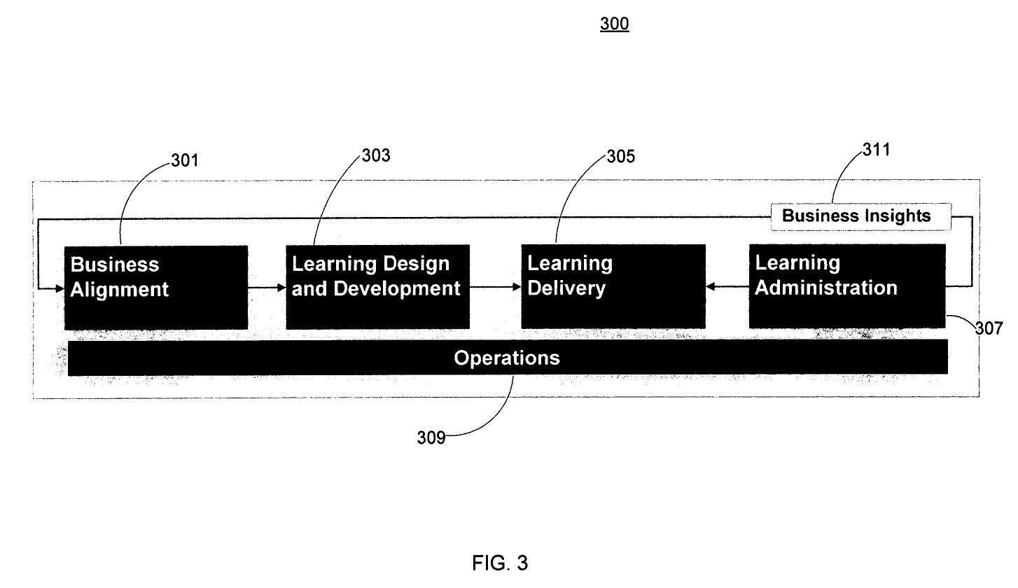

FIG. 3 shows architecture 300 for training supply chain components according to an embodiment of the invention. In the embodiment shown in FIG. 3, architecture 300 is referred as a capability assessment model (CAM). Architecture 300 includes business alignment component 301, learning (training) design and development (303), learning (training) delivery 305, learning (training) administration 307, and operations 309.

Business alignment component 301 corresponds to aligning training needs with the business objectives of the company. Learning design and development component 303 corresponds to building, buying, and reusing content based on training and document objectives. Learning delivery component 305 corresponds to providing high quality training and documentation across a mixture of delivery media. Learning administration component 307 provides learning management and administrative services. Operations component 309 encompasses service control, service integration, and continuous improvement. Business insights component 311 provides insight to how learning links to business performance.

The capability assessment reference model, as depicted by architecture 300, is used to profile a specific company against certain learning (i.e., training) capability criteria to determine its relative position compared with the profile for the industry segment where it competes. For companies that find themselves at a significant disadvantage compared with competitors and/or industry norms, a specific program can be designed to address the shortfall. Similarly, for companies that have been leaders in learning and building capabilities, the capability assessment can help define the direction for future investments and measurement of results.

Organizations that regularly meet or exceed the level of learning capability and maturity required in their industry segment and that of their key competitors may have a sustainable competitive advantage. This competitive advantage will be recognized in sustained superior returns. The capability assessment model enables companies to determine what areas of the training supply chain companies should invest in to achieve these returns.

For companies that find themselves at a significant disadvantage compared with competitors and/or industry norms, a specific program can be designed to address the shortfall. Similarly, for companies that have been leaders in learning and building capabilities, the capability assessment can help define the direction for future investments and measurement of results. A program defined for any particular company will vary based on the results of the assessment.

Other training assessment models often assume that an organization should strive to the highest level of capability sophistication. However, the capability assessment model, e.g., the assessment model shown in FIG. 3, assumes that a company should meet or exceed the level of capability sophistication for its particular industry. However, while the exemplary embodiment of the invention incorporates the capability assessment model, other embodiments of the invention may utilize other assessment models.

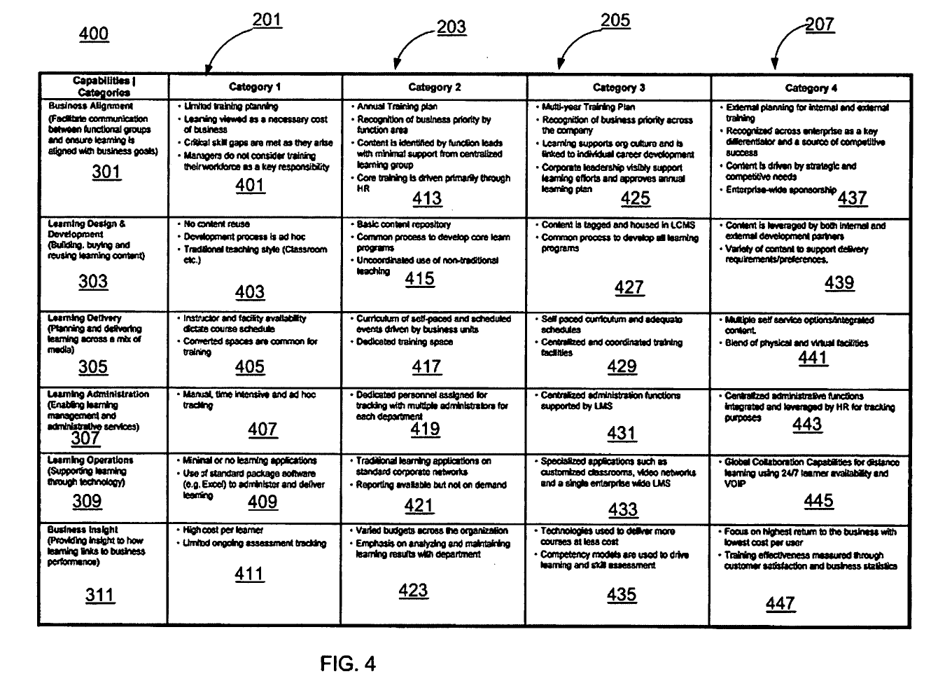

FIG. 4 shows training supply chain components according to an embodiment of the invention. Characteristics sets (401-447) that are associated with different training supply chain components (301-311) in relation to different categories (201-207) are shown in matrix 400. For example, learning (training) administration component 301 maps to characteristics set 425 (e.g., centralized administration functions supported by a Learning Management System “LMS”) for category 3 (205).

Category criteria for capability assessment includes:
Complexity of products and offerings
Frequency of changing content
Need for extended enterprise learning
Centralized vs. decentralized operating environment
Maturity of industry

While a company may be considered a company corresponding to a particular category, as discussed with FIG. 1, typically a company may have characteristic sets of varying category levels as a function of training supply chain components. For example, a category 3 company may be associated with the majority of training supply chain components having characteristic sets in category 3 with some of the remaining components in either category 2 or category 4.

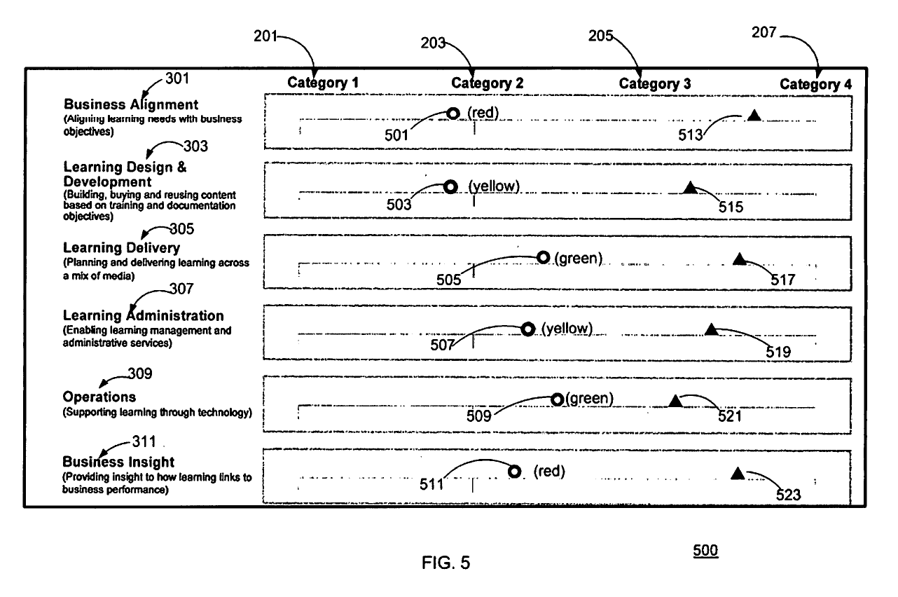

FIG. 5 shows exemplary assessment results report 500 according to an embodiment of the invention. Exemplary report 500 shows the assessment of a client company (corresponding to circularly-shaped indicia 501-511) in relation to the leader in the associated business segment (triangularly-shaped indicia 513-523) for training supply chain components (301-311). The company is assessed on a continuous scale 1-4, corresponding to categories 201-207.

Companies in the business segment (e.g., wireless telecom) are surveyed to profile characteristics for training supply chain components 301-311. As previously discussed, most of the learning (training) capabilities of companies in the wireless telecom segment are typically in category 4, so that most, if not all, of the training supply chain components are assessed as having category 4 characteristic sets. However, a steel manufacturing company may be typically classified in category 2 so that few, if any, training supply chain components are assessed as having category 4 characteristics sets.

In an exemplary study, training data was collected for category 3 and 4 companies (primarily technology and communications companies). Additional data was collected from two hundred seventy six category 3 and 4 companies using an online survey having between 46 and 50 questions. Most online companies surveyed employ between 10,000 and 40,000 people. Six components (corresponding to business alignment component 301, learning design and development component 303, learning delivery component 305, learning administration component 307, operations component 309, and business insight component 311) were assessed. Each company was given a rating for each of the learning capabilities. The ratings were assigned as follows:
A round score of 1-4 was assigned if there was a clear fit within a single stage.
0.5 was assigned if there was an equal distribution of characteristics between two stages.
0.25 and 0.75 were assigned if there was an unequal distribution of characteristics between two stages.

Because of the competitive nature of business, a company typically expends only the resources (e.g., money) that are justified by the corresponding benefits. For example, spending more money may not result in increased benefits. Referring to FIG. 5, the client company (corresponding to assessments 501-511) is compared to the leader in the industry segment. In exemplary report 500, the business segment leader is rated somewhere between categories 3 and 4, where training supply chain components 301-311 are rated from 3.2 to 3.7. Correspondingly, the client company is rated between a category 2 company and a category 3 company, where training supply chain components 301-311 are rated between 1.8 to 2.4. For example, a client company is rated 1.8 while business segment leader is rated 3.7 for business alignment component 301. The corresponding difference (1.9) between rating is the most pronounced for training supply chain components 301-311. However, client company is rated 2.4 while the business segment leader is rated 3.2 for operations component 309, corresponding to a difference of 0.8.

Indicia 501-511 may be color coded to designate how effective the company is at operating the corresponding training supply component at the specified maturity category. For example, as previously discussed, the rating difference between the client company and the leader of the business segment is 1.9 for business alignment component 301 and 0.8 for operations component 309. Correspondingly, indicia 501 may be color coded “red” indicating poor operational execution while indicia 509 may be color coded “green” for excellent operational execution. Other embodiments of the invention may distinguish the category differences in other ways such as with text or different indicia types.

While exemplary report 500 compares the client company with the business segment leader, the client company may be compared other references such as with an average in the associated business segment or with a judgmental target (e.g., determined by a consultant) for the business segment. The judgmental target may project the future direction in an industry.

Referring the FIGS. 3 and 5, one may associate each training supply chain component with a current category, current characteristics set that is associated with the current category and industry segment, targeted category, targeted characteristics set, and recommended actions for the client company to reach the targeted category.

As exemplified by report 500, capability assessment provides a way to define the ability of an organization to create capability in its workforce and its extended value chain on a recurring basis.

Organizations that regularly meet or exceed the level of learning capability and maturity required in their industry segment and that of their key competitors may have a sustainable competitive advantage. This competitive advantage will be recognized in sustained superior returns.

A company can be profiled against certain criteria to determine its relative position compared with the profile for the industry segment in which the company competes. For example, a certain level of capabilities for one company may provide a significant competitive advantage relative to its peers. However, that same level of capability for another company in a more rapidly changing, knowledge-intensive environment may indicate a significant disadvantage.

For companies that find themselves at a significant disadvantage compared with competitors and/or industry norms, a specific program can be designed to address the shortfall. Similarly, for companies that have been leaders in learning and building capabilities, the capability assessment can help define the direction for future investments and measurement of results.

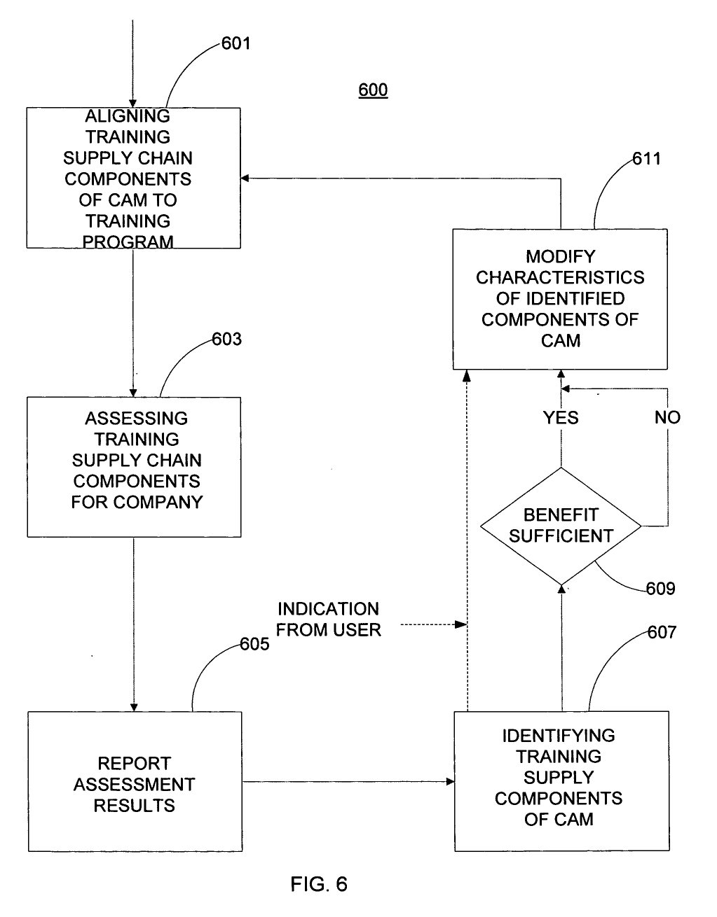

FIG. 6 shows flow diagram 600 that assesses a training program according to an embodiment of the invention. In step 601, input data that is descriptive of the client company's training program is obtained. In the embodiment, the input data includes information regarding current training characteristics for the client company for each of the training supply chain components of the capability assessment model. Possible training characteristics reflect the characteristics shown in FIG. 4. The obtained training characteristics are aligned to each of the training supply chain components.

In step 603, each of the components is assessed with respect to training characteristics of a reference. In the exemplary embodiment, the reference is the leader in the associated business segment. An assessment results report is generated in step 605. An exemplary assessment results report is shown in FIG. 5.

For a given component, if the category of the reference is sufficiently greater than the determined category of the client company, the component is identified for suggested improvement in step 607. For example, as shown in FIG. 5, indicium 511 is shown in red to indicate that the current category of business insight component 311 is operating significantly less than that of the business segment leader. (In some of the embodiments of the invention, a component may be identified by text, shape, or some other distinguishing quality.) The disparity between the current category and the corresponding category of the business segment leader may be sufficiently large to warrant modification in order for the client company to be competitive in its industry segment.

In step 609, the identified components are analyzed to determine if the identified components should be modified based on economic considerations. If the benefit for modifying an identified component sufficiently large with respect to the cost of modifying the identified component, as determined by step 609, the set of training characteristics of the component are modified. For example, if the current characteristics for business insights component 311 is “varied budgets across the organization” and “emphasis on analyzing and maintaining learning results with a department” (corresponding to category 2 that is shown as characteristics set 423 in FIG. 4), step 611 modifies the displayed characteristics to be “technologies used to deliver more courses at less cost” and “competency models are used to drive learning and skill assessment” (corresponding to category 3 that is shown as characteristics set 435). Additionally, step 611 may provide actions that the client company should perform in order to change the characteristics. For example, for the above example, step 611 suggests that the client company deliver internal courses through the Internet rather than distributing CD-ROMs to employees in order to deliver more courses at less cost.

The embodiment also enables a user to input an indication whether to modify the identified components rather than analyze the cost/benefits of the identified components.

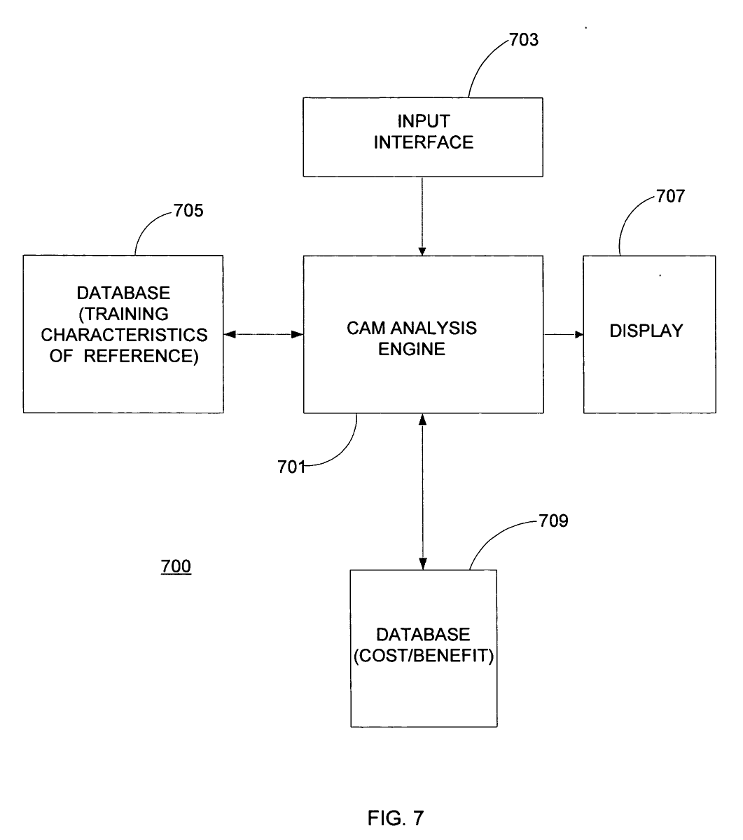

FIG. 7 shows apparatus 700 that analyzes a training program of a client company in accordance with an embodiment of the invention. Analysis engine 701, which is implemented as a processor in the embodiment, obtains input data through input interface 703. The input data includes training descriptive data that describes the training program of the client company. In the embodiment, the training descriptive data is provided in a spreadsheet, e.g., Microsoft® Excel. Input interface 703 supports inputting reference data that describes training characteristics of a reference, e.g., the business segment leader.

Database 705 provides training characteristics for a reference that is compared to the training descriptive data of the client company. Analysis engine 701 aligns the characteristics to the capability assessment model to provide an assessment report, e.g., report 500 as shown in FIG. 5) to display 707.

Database 709 provides cost/benefit data to determine if modifying characteristics of a component is economically justifiable (corresponding to step 609 in FIG. 6).

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A computerized method for analyzing training supply chain components in a training program of a company, comprising:
(a) aligning characteristics of the training program with a set of training supply chain components of a capability assessment model;
(b) assessing the set of training supply chain components for the company; and
(c) reporting assessment results to show a comparison of the training program with training characteristics of other companies.

2. The computerized method of claim 1, further comprising:
(d) recommending, from the assessment results, a set of characteristics of the at least one component of the capability assessment model.

3. The computerized method of claim 1, wherein the set of training supply chain components comprises a business alignment component, a learning design component, a learning delivery component, a learning administration component, an operations component, and a business insight component.

4. The computerized method of claim 1, wherein (b) comprises:
(b)(i) categorizing each component of the set of training supply chain components for the company; and
(b)(ii) determining an evaluated rating for each said component for the company.

5. The computerized method of claim 4, wherein (c) comprises:
(c)(i) comparing the evaluated rating for each said component with a reference rating for a business segment leader.

6. The computerized method of claim 5, wherein (c) further comprises:
(c)(ii) identifying the evaluated rating by an identification indicia in a report.

7. The computerized method of claim 6, wherein (c)(ii) comprises:
(c)(ii)(1) determining a difference between the evaluated rating and the reference rating; and
(c)(ii)(1) generating the identification indicia from the difference.

8. The computerized method of claim 1, further comprising:
(d) determining a benefit and a corresponding cost for modifying the set of characteristics of the at least one component, wherein an expected profit is determined.

9. The computerized method of claim 8, further comprising:
(e) if the expected profit is greater than a predetermined amount, modifying the set of characteristics.

10. The computerized method of claim 9, wherein (e) comprises:
(e)(i) presenting at least one action to modify the set of characteristics.

11. The computerized method of claim 1, further comprising:
(d) displaying an output that identifies the at least one component of the capability assessment model.

12. The computerized model of claim 11, further comprising:
(e) in response to (d), receiving an indication to modify training characteristics that are associated with the capability assessment model for the company.

13. The computerized model of claim 4, wherein the evaluated rating corresponds to a category, wherein each category is determined from a percentage of companies within a corresponding business segment.

14. An apparatus that analyzes a training program of a company in a business segment, comprising:
an input interface that obtains training characteristics data of the training program; and
a processor that aligns the training characteristics data with a capability assessment model, that compares the training characteristics data with training comparison data for a reference in the business segment, and that provides an assessment report from the capability assessment model.

15. The apparatus of claim 14, further comprising:
a first data structure that contains the training comparison data for the reference.

16. The apparatus of claim 14 wherein the processor obtains an indication to modify the training characteristics of at least one component of the capability assessment model that models the training program.

17. The apparatus of claim 14, further comprising:
a second data structure that includes cost and benefit information related to modifying the training characteristics of the at least one component; and
wherein the processor analyzes the capability assessment model using the cost and benefit information.

18. The apparatus of claim 14, further comprising:
a display that is coupled to the processor and that displays the assessment report.

19. A method for providing an assessment results report for a training program of a company, the company being associated with a business segment, the method comprising:
(a) obtaining first information indicative of training characteristics of a reference within the business segment;
(b) obtaining second information indicative of the training program;
(c) aligning the first information and the second information to a training model;
(d) generating a first indicium with the assessment results report, the first indicium representing a reference assessment for the reference; and
(e) generating a second indicium with the assessment results report, the second indicium representing a determined assessment for the company.

20. The method of claim 19, wherein the training model comprises a capability assessment model, and wherein the first indicium and the second indicium are associated with a training supply chain component.
